(19) United States
(12) Patent Application Publication
(10) Pub. No.: US 2013/0306320 A1
(43) Pub. Date: Nov. 21, 2013

(54) COMPOSITION AND METHOD FOR TREATING CARBONATE RESERVOIRS

(71) Applicants: MSALLI AWADH ALOTAIBI, LAKEWOOD, CO (US); IBNELWALEED A. HUSSEIN, DHAHRAN (SA); GHAITHAN A. AL-MUNTASHERI, DHAHRAN (SA); FRANK F. CHANG, AL-KHOBAR (SA)

(72) Inventors: MSALLI AWADH ALOTAIBI, LAKEWOOD, CO (US); IBNELWALEED A. HUSSEIN, DHAHRAN (SA); GHAITHAN A. AL-MUNTASHERI, DHAHRAN (SA); FRANK F. CHANG, AL-KHOBAR (SA)

(73) Assignees: SAUDI ARABIAN OIL COMPANY, DHARAN (SA); KING FAHD UNIVERSITY OF PETROLEUM AND MINERALS, DHAHRAN (SA)

(21) Appl. No.: 13/476,709

(22) Filed: May 21, 2012

(51) Int. Cl. E21B 43/25; C09K 8/60

(52) U.S. Cl. 166/307; 507/241

(57) ABSTRACT

The composition and method for treating carbonate reservoirs provides a treatment fluid for the acid treatment of stratified subterranean formations. The treatment fluid is injected into a non-problematic or high permeability zone of a carbonate reservoir. The treatment fluid is formed from a zwitterionic viscoelastic surfactant, which forms about 7.5 vol % of the treatment fluid, hydrochloric acid forming about 15.0 vol % of the treatment fluid, and a corrosion inhibitor forming about 0.6 vol % of the treatment fluid, the balance being brine. The treatment fluid gels as the hydrochloric acid reacts with carbonate of the carbonate reservoir, thus forming a diverting block in the non-problematic or high permeability zone. Following formation of the diverting block, a further volume of the treatment fluid is injected into the carbonate reservoir. The diverting block diverts the treatment fluid into a problematic or low permeability zone of the carbonate reservoir.

### BACKGROUND OF THE INVENTION

1. Field of the Invention

The present invention relates to carbonate reservoirs, and particularly to a composition and method for treating carbonate reservoirs that provides a treatment fluid including a viscoelastic surfactant for fluid diversion.

2. Description of the Related Art

In a wide variety of oilfield treatments, in which treatment fluids are injected into a formation through a wellbore, the formation being treated is stratified. Typically in such stratified formations, the permeabilities of the strata differ, sometimes substantially. Also, typically one or more of the strata (the oil-containing zone(s)) will often contain potentially producible hydrocarbons in the form of oil, condensates, or gas. Often, one or more other strata (the water-containing zone(s)) will contain in its pores entirely, or almost entirely, only water or brine formations, and will contain either no hydrocarbons or only residual hydrocarbons remaining after the producible hydrocarbons have already been produced from that zone. This zone produces fluid that is all or mostly water.

The low permeability zone or zones are considered to be “problematic” because they contain hydrocarbons that are not being produced properly. The high permeability zones that are producing fluid, either water or hydrocarbons or both, are considered to be “non-problematic”, even though water production is typically undesirable. By definition, the “problem” is that a zone is not producing or not producing satisfactorily, so by this definition a zone that is producing is “non-problematic”.

If both oil and water phases are present in a zone, but some or all of the producible oil has been produced, the zone is considered to be a water-containing zone. In this case, water is typically the continuous phase, and the flowing phase, and the water saturation is high. The permeability to injected fluid of the water-containing zone is greater than the permeability to injected fluid of the oil-containing zone.

In other cases, there is no water-containing zone, but there is permeability stratification of the hydrocarbon-containing zones or strata. In such cases, oil will be produced preferentially from the more permeable zones, termed “non-problematic”. The less permeable zone or zones are considered problematic because, again, they contain hydrocarbons that are not being produced properly. They could be problematic because they are inherently less permeable (because of the geology, for example) or because they have been damaged.

In many oilfield treatments, it is desirable to inject all or most of the injected fluid into one or more specific problematic oil-containing zones; i.e., stratum or strata that contain potentially producible hydrocarbons that are not, or will not, be satisfactorily produced, and not into other zones. These zones are problematic because they are oil containing but are not or will not satisfactorily produce the hydrocarbons that they contain. In the situations of primary interest, production from these problematic zones is unsatisfactory because there are more productive (i.e., non-problematic) zones. These more productive zones may be water-containing zones that produce water. On the other hand, there may not be water zones, but the problematic zones may inherently have lower permeabilities than the other zones or may have been damaged in a drilling, completion or production process, so that some oil-containing zones can or will produce oil and others can or will not. For example, in hydraulic fracturing (including acid fracturing) an optimal treatment would place the fracture entirely in the problematic zone(s). Similarly, in acidizing treatments (of sandstone formations to remove damage, or of carbonate formations to create flow paths, such as wormholes) an optimal treatment would be one in which all the injected fluid was placed in the problematic zone.

These requirements are important because the objects of such treatments are to increase the permeability or the volume (or both) of the flow path for fluids in the problematic zone, while not creating such increases in water-containing zones, or, if there are no water-containing zones, creating greater increases in the problematic zones than in the other zones. Further, treatment fluid injected into a water-containing zone is, at best, wasted (and that zone is typically referred to as a “thief” zone) even if it does not enhance the flow path there. Worse, treatment fluid injected into a water-containing zone could increase water production. In practice, treatments often do not go primarily into the problematic zones.

Conventionally, the “problematic” zones are described as though they are problematic relative to water-containing zones, although it should be appreciated that problematic zones may be problematic relative to oil-containing zones. Similarly, the zones into which it is desired to inject treatment fluids are typically described as “oil-containing” zones, even though, in some cases, all the zones, including the thief zones, are oil containing. Typically, undiverted treatments enter thief zones having high water saturation (because the treatments are aqueous) and/or high permeability (because fluids follow the path(s) of least resistance). Methods devised to increase injection into the problematic oil-containing zone, even if it has lower permeability, are called diversion methods, and mechanical devices or chemicals used in them are called diverters.

Some of the simple chemical diverting agents that have been used in the past include oil-soluble resins, water-soluble rock salt, and emulsions. Viscoelastic diverters are used primarily in acidizing and fracturing. They are also used with both sandstone and carbonates. Viscoelastic diverters may also include an optional water-soluble organic salt and/or alcohol to improve viscoelasticity under severe conditions. Diversion with such diverters may be temporary or permanent. The micelles are broken by dilution, by formation of water, or by contact with hydrocarbons, but surfactant molecules of the diverter remain intact. Some surfactants sometimes cause emulsions when they contact certain oils. If this occurs in fracturing or in carbonates, it is unlikely to cause damage if the carbonate-acidizing left large wormholes and if the fracturing left large flow paths. Flow through these is unlikely to be impeded by the presence of emulsions. However, emulsions could impede flow through the smaller flow paths remaining after sandstone acidizing, or if small fractures or small wormholes were created.

It is also known to use self-diverting acids, typically consisting of hydrochloric acid mixed with a polymeric gelling agent and a pH-sensitive cross-linker in matrix acidizing. Self-diverting acids are typically designed to gel at intermediate pH values, when the acid is partially spent.

Often, diversion methods either cause damage by leaving behind particles, polymer, sludge, precipitates, surfactants, etc. and/or are expensive and complicated and/or require specialized equipment and facilities (for example, to generate, monitor, and control foams). Further, many chemical diverters cannot be used at high temperatures or are incompatible with some chemicals (such as strong acids or very low or very high salt concentrations). There exists a need for simple, inexpensive and easy to use compositions and methods for diversion of injected fluids.

Thus, a composition and method for treating carbonate reservoirs solving the aforementioned problems is desired.

### SUMMARY OF THE INVENTION

The composition and method for treating carbonate reservoirs relates to the acid treatment of stratified subterranean formations, such as carbonate reservoirs. A treatment fluid is injected into a non-problematic or high permeability zone of a carbonate reservoir. The treatment fluid is formed from a zwitterionic viscoelastic surfactant, which forms about 7.5 vol % of the treatment fluid, hydrochloric acid forming about 15.0 vol % of the treatment fluid, a corrosion inhibitor forming about 0.6 vol % of the treatment fluid, and brine forming the balance of about 76.9 vol % of the treatment fluid. The treatment fluid gels as the hydrochloric acid reacts with carbonate of the carbonate reservoir, thus forming a diverting block in the non-problematic, or high permeability, zone. Following formation of the diverting block, a further volume of the treatment fluid is injected into the carbonate reservoir. The diverting block diverts the treatment fluid into a problematic or low permeability zone of the carbonate reservoir.

These and other features of the present invention will become readily apparent upon further review of the following specification and drawings.

### BRIEF DESCRIPTION OF THE DRAWINGS

FIG. 1 is a chart illustrating the diversion efficiency of a composition for treating carbonate reservoirs according to the present invention using carbonate core samples having a permeability contrast of 28.2 fold.

FIG. 2 is a graph illustrating pressure drop across a parallel core sample as a function of time with a conventional straight acid treatment.

FIG. 3 is a graph illustrating pressure drop across a parallel core sample as a function of time using the composition for treating carbonate reservoirs according to the present invention.

FIG. 4 is a chart illustrating the permeability contrast effect on diversion efficiency of the composition for treating carbonate reservoirs.

FIG. 5 is a plot showing the permeability contrast effect on diversion efficiency of the composition for treating carbonate reservoirs.

FIG. 6 a chart illustrating the permeability contrast effect on diversion efficiency of the composition for treating carbonate reservoirs using a viscoelastic surfactant concentration of 3.75 vol %.

FIG. 7 is a chart comparing permeability enhancement of the composition for treating carbonate reservoirs using a viscoelastic surfactant concentration of 3.75 vol % and a viscoelastic surfactant concentration of 7.5 vol %.

FIG. 8 is another chart comparing permeability enhancement of the composition for treating carbonate reservoirs using a viscoelastic surfactant concentration of 3.75 vol % and a viscoelastic surfactant concentration of 7.5 vol %.

FIG. 9 is a chart comparing permeability enhancement of the composition for treating carbonate reservoirs using seawater and field water as carrying fluid components.

FIG. 10 is a chart comparing permeability enhancement of the composition for treating carbonate reservoirs using seawater and distilled water as carrying fluid components.

FIG. 11 is a chart comparing permeability enhancement of the composition for treating carbonate reservoirs using field water and distilled water as carrying fluid components.

Similar reference characters denote corresponding features consistently throughout the attached drawings.

### DETAILED DESCRIPTION OF THE PREFERRED EMBODIMENTS

The composition and method for treating carbonate reservoirs relates to the acid treatment of stratified subterranean formations, such as carbonate reservoirs. A treatment fluid is injected into a non-problematic or high permeability zone of a carbonate reservoir. The treatment fluid is formed from a zwitterionic viscoelastic surfactant, which forms about 7.5 vol % of the treatment fluid, hydrochloric acid forming about 15.0 vol % of the treatment fluid, a corrosion inhibitor forming about 0.6 vol % of the treatment fluid, and brine forming the balance of about 76.9 vol % of the treatment fluid. The brine forms the carrying fluid of the treatment fluid. Preferably, the zwitterionic viscoelastic surfactant is erucrylamidopropyl betaine.

In use, the treatment fluid gels as the hydrochloric acid reacts with carbonate of the carbonate reservoir, thus forming a diverting block in the non-problematic, or high permeability, zone. Following formation of the diverting block, a further volume of the treatment fluid is injected into the carbonate reservoir. The diverting block diverts the treatment fluid into a problematic or low permeability zone of the carbonate reservoir.

In order to test the effectiveness of the treatment fluid, the zwitterionic viscoelastic surfactant was provided as a fresh sample, the corrosion inhibitor being added to the hydrochloric acid to prevent corrosion of the acidic solution while flowing in the core flood lines. To investigate the effect of carrying fluid salinity, three water salinities were tested, viz., distilled water, field water and seawater. The seawater formulation used resembled that of Arabian Gulf seawater. The field water was a field water commonly used in Saudi Arabia for lab evaluation. The chemical compositions of the seawater and the field water used in the study are shown below in Table 1, where total dissolved solids (TDS were determined by addition):

TABLE 1
Field Water and Seawater Chemical Analysis

| Constituent/ | Field Water | Seawater |
|---|---|---|
| parameter | (mg/L) | (mg/L) |
| Ca | 126 | 592 |
| Mg | 53 | 2,304 |
| Na | 228 | 19,325 |
| K | 14 | 730 |
| Cl | 361 | 31,106 |
| SO₄ | 233 | 4,108 |
| HCO₃ | 171 | 183 |
| TDS | 1,186 | 58,348 |
| pH | 7.8 | 7.9 |

Experimental core samples were subjected to experimental core flooding, and were collected from Indiana limestone and desert pink limestone outcrops. Each core sample had a length of about nine inches and a diameter of about 1.5 inches. A total number of twenty-six core samples were used in the experimental study. The chemical compositions of the core samples used are shown below in Table 2. The Indiana and desert pink limestone cores have the same composition as 100% calcite. The permeability variations in the samples selected were intentionally chosen to study the permeability contrast effect on the diversion efficiency of the visco elastic surfactant-acid treatment fluid. The core samples used, along with their permeability values, are shown below in Table 3:

TABLE 2
Chemical Composition of Core Samples

| | Indiana Limestone | Desert Pink Limestone |
|---|---|---|
| | (wt %) | (wt %) |
| Calcite (CaCO₃) | 100 | 100 |
| Dolomite (CaMg(CO₃)₂) | 0 | 0 |

TABLE 3
Permeability Ranges of Core Samples

| Sample Number | Permeability (mD) | Sample Number | Permeability (mD) |
|---|---|---|---|
| 1 | 0.58 | 14 | 2.68 |
| 2 | 0.69 | 15 | 4.18 |
| 3 | 0.70 | 16 | 4.55 |
| 4 | 0.70 | 17 | 4.95 |
| 5 | 0.76 | 18 | 6.44 |
| 6 | 0.79 | 19 | 27.50 |
| 7 | 0.95 | 20 | 30.18 |
| 8 | 0.96 | 21 | 31.25 |
| 9 | 0.98 | 22 | 34.37 |
| 10 | 1.29 | 23 | 37.33 |
| 11 | 1.45 | 24 | 40.31 |
| 12 | 2.00 | 25 | 40.91 |
| 13 | 2.19 | 26 | 56.25 |

The different brines used in the study were 3% KCl brine, Arabian Gulf seawater, and the regular field water, as shown in Table 1. The brines were mixed first using distilled water, and then filtered through 0.3 micron filter paper before testing. Further, in the experiment, 15% HCl concentrations were prepared from a 37% assay acid container. The acid was mixed after preparing and filtering the brine. The mixing was conducted using a magnetic stirrer to ensure uniform mixing. Then, the corrosion inhibitor and the erucrylamidopropyl betaine viscoelastic surfactant (VES) were added using a blender to ensure uniform mixing. The VES was added slowly to the mixture while blending for about five minutes. The resultant solution foamed due to the mixing process. The foaming mixture was then degassed by centrifuging for five minutes at 3,000 RPM.

Parallel core flood equipment was used to study the diversion efficiency of the present treatment fluid. The core flood system was designed to run two parallel core floodings. The apparatus consisted of an oven, positive displacement pumps, accumulators, a confining pump, two core holders, a back pressure regulator, and a data acquisition system. Each core holder can accommodate a core sample having a diameter of 1.5 inches and a variable length. The core holders were placed inside a temperature-controlled, forced-air circulation oven. The positive displacement pumps delivered a consistent and continuous flow rate. Pressure transducers were used to measure pressure drop across the core samples. A back-pressure regulator was used downstream of the core to control flowing pressure. The confining pump was used to maintain a constant confining pressure on the core samples during the experiment. Accumulators with floating pistons were used to store and inject fluids. The data acquisition system utilized software to control the variables of the experiment, such as the fluid flow rate and flow direction.

The core samples were first placed inside the parallel core holders. Then, the confining pump was used to apply a confining pressure of 2,000 psi. The back pressure was set at 1,000 psi, and the temperature of the oven was set at 150° F. Following this, 3% KCl brine was injected at a flow rate of 2 mL/min through each mounted core sample until reaching a steady-state pressure drop across the core samples. This was performed in sequence. Once the first sample reached the steady-state base permeability value, the flow was switched to the other core sample for base permeability measurement. The pressure drop across the core sample was automatically recorded with time.

After establishing the base permeability for the mounted core samples, the treatment fluid was prepared and loaded in the accumulators for injection. The injection rate was selected to be 5 mL/min. The flow rate was maintained until one of the core samples encountered breakthrough, when the pressure drop went to almost zero. After that, the pump was stopped and the treatment fluid was cleaned from the lines of the system. While injecting the treatment, the pressure drop across the samples was automatically recorded with time.

The return permeability was established by injecting the 3% KCl brine at a 2 mL/min flow rate until reaching a steady-state pressure drop across the core sample. The return permeability values were used to measure the enhancement of the treatment on the core sample. The permeability of the core sample in the base and return stages were calculated using Darcy's law. The enhancement of the treatment was calculated as

$${K}_{rp} = \frac{{K}_{r}}{{K}_{b}} \times 100 ,$$

where Kᵣₚ is the retained permeability (%) (i.e., the permeability enhancement), K_{b} is the base permeability (mD), and Kᵣ is the return permeability (mD).

The diversion efficiency of the treatment fluid was evaluated by measuring the retained permeability. For each core flood experiment, the retained permeability value was taken for the tighter core sample, as the higher permeability core sample had infinite retained permeability. The retained permeability value was used to compare and rank the diversion efficiencies obtained for different core flood experiments. The higher the retained permeability, the more efficient was the diversion of the treatment fluid.

The first indicator that was used to evaluate the diversion efficiency of the treatment fluid was the return permeability results obtained from the parallel core flooding experiments. The core flooding experiments were conducted using two carbonate core samples, samples 25 and 11. Sample 25 had a base permeability of 40.91 mD, whereas sample 11 had a permeability of 1.45 mD. The permeability contrast between the two samples is 28.2 times. The treatment fluid was injected simultaneously in the two core samples until a breakthrough was reached.

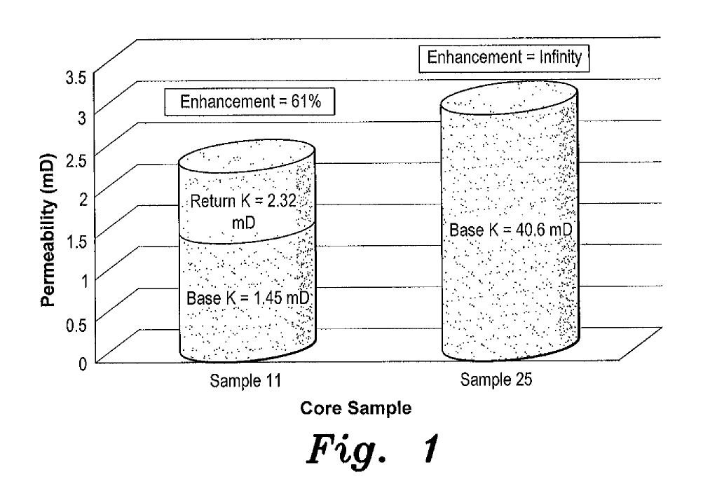

The higher permeability core sample (sample 25) showed infinite enhancement, as a breakthrough was reached while injecting the treatment fluid. The tighter core sample (sample 11) showed an enhancement of 61% in the base permeability of the tighter core sample. This enhancement signifies the diversion efficiency of the treatment fluid, since the acid was diverted to the tighter core sample and permeability was enhanced. The results are shown in FIG. 1.

As is known in the field of wellbore treatment, straight acid treatments yield almost no enhancement to the permeability of the tighter core sample. This is because the injected acid will first flow to the higher permeability core sample, since it provides the least resistance path for flow. Once the acid reaches the face of the core sample, it will start reacting with the carbonate materials, creating more channels and increasing the sample permeability. This results in stimulating only the higher permeability core sample, leaving the tighter core sample unstimulated. The comparison between straight acid treatment and treatment with the present treatment fluid is shown below in Table 4:

TABLE 4
Comparison between Straight Acid Treatment and Treatment Fluid

| | 15% HCl Acid | Treatment Fluid |
|---|---|---|
| Core Sample 1 Permeability (mD) | 101 | 40.9 |
| Core Sample 2 Permeability (mD) | 6 | 1.45 |
| Contrast (as a multiple) | 16.8 | 28.2 |
| Enhancement in Core Sample 1 (%) | Infinite | Infinite |
| Enhancement in Core Sample 2 (%) | 0 | 61 |

The results from the treatment fluid show different behavior and results when compared to the straight acid system. The treatment fluid favors the higher permeability core sample at the beginning. As more acid reacts with the higher permeability core sample, more viscosity is created in the treatment fluid. This results in hindering the flow and increasing the pressure drop. When the pressure drop reaches a point where it is higher than the pressure drop across the tighter core sample, the treatment fluid will be diverted to the other core sample, resulting in stimulating both core samples.

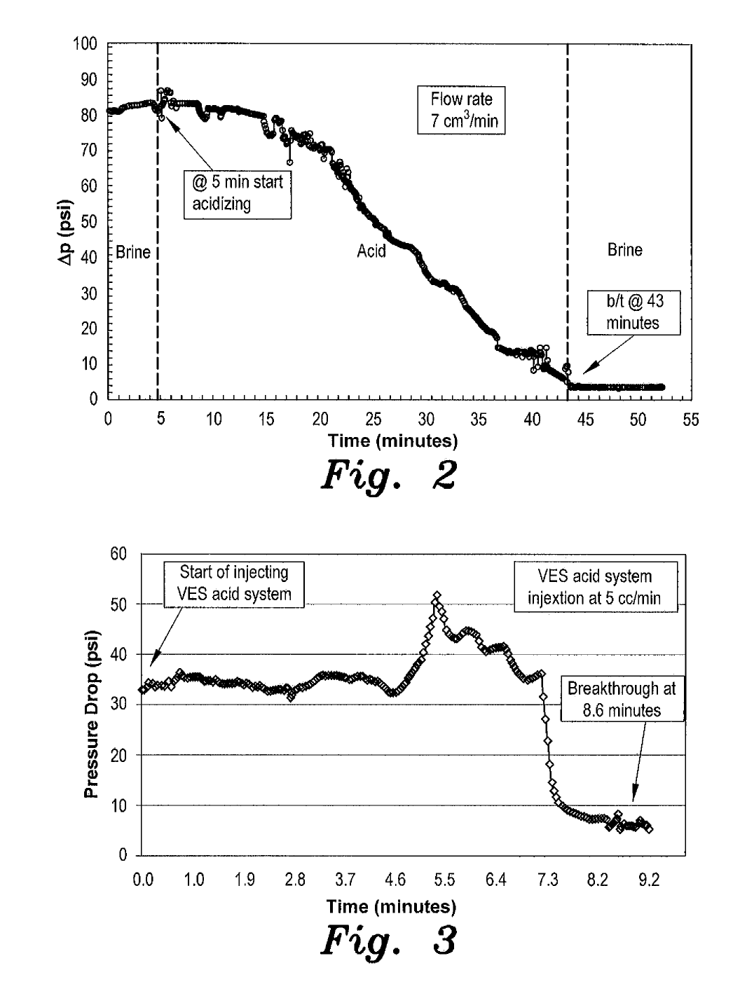

The pressure drop with time while injecting the treatment fluid was recorded and monitored in order to evaluate the diversion behavior of the treatment fluid. The generated pressure drop was compared with a straight acid injection pressure drop. As is known in the field, the pressure drop obtained from a parallel core flooding experiment declines with time in a continuous pattern until reaching a breakthrough. This is because, as the acid reacts with the calcium carbonate, conductive channels are created, thus reducing the pressure drop with time. FIG. 2 illustrates the pressure drop associated with treatment with straight acid. In FIG. 2, it can be seen that the acid results in a continuous decline in the pressure drop with time.

Unlike the straight acid system, the present treatment fluid shows a different pressure drop behavior. The pressure drop obtained from the parallel core flooding injection of samples 11 and 25 is shown in FIG. 3. As shown in FIG. 3, the pressure drop starts at a value of around 33 psi and fluctuates around that value, even after four minutes of injection. The pressure drop kept fluctuating for more than 50% of the injection time before reaching a breakthrough when the pressure drop between the inlet and the outlet of the core sample became almost zero. The fluctuation was followed by a steep increase in the pressure drop by more than 60% of the original pressure drop, and then a decline in the pressure drop until reaching a breakthrough at 8.6 minutes. The pressure drop behavior observed while injecting the treatment fluid indicates an increase in the fluid viscosity, which is believed to be the main reason for the diversion shown in the 61% enhancement in the tight core sample permeability.

The fluctuation observed in the pressure drop while injecting the treatment fluid is primarily attributed to the counter-effect between viscosity change (increase) and the sample permeability increase. The reaction of the HCl acid contained in the treatment fluid with the carbonate rock results in an increase in the permeability and porosity of the core sample, which causes the pressure drop to decrease. Meanwhile, the fluid viscosity build-up due to produced CaCl₂ and increasing pH (above 4) leads to a pressure drop increase.

The counter-effects of both factors (rock dissolution and fluid viscosity increase) are shown in FIG. 3. At the beginning, the effects appear to have equal magnitude, resulting in a fluctuating behavior around 33 psi. However, after four minutes from injection, the pressure drop increases steeply above 50 psi, indicating an overtake by the viscosity effect. Following this stage, a continuous decline in pressure drop occurs, until reaching a breakthrough, thus indicating a more dominant effect by the dissolution as the effective core length is significantly shortened.

Some reservoirs in Saudi Arabia are heterogeneous, having high permeability contrasts ranging from 1 mD to 1,000 mD. Treatments applied on the long horizontal sections of a carbonate reservoir oil well can be exposed to this range. The present treatment fluid is capable of diverting the acid treatment from high permeable zones to lower permeable zones. The permeability contrast effect was studied by using carbonate core samples with different permeabilities. The core samples were selected from Table 3 to have various permeability contrasts folds. The studied permeability contrasts used were 3.4, 28.2 and 44.5 folds. The study was evaluated at two VES concentrations, viz., 7.5% VES and 3.75% VES.

The first VES concentration that was evaluated was 7.5% VES. Two core samples were selected (samples 1 and 12) with permeabilities of 0.584 mD and 2.00 mD, respectively, in order to evaluate the diversion efficiency at the low range of 3.4 folds. The base permeability of each core sample was first established using 3% KCl and followed by treatment fluid injection. The results showed that the return permeability of the more permeable sample was infinite, while the return permeability of the tighter core sample increased from 0.584 mD to 5.392 mD.

The increase in the permeability of sample 1 corresponded to an enhancement of 824% of its original permeability. The diversion here was shown to be of a high magnitude, and this is attributed to the low permeability contrast of 3.4 folds. The permeability contrast was increased to 28.2 folds using two core samples with permeabilities of 1.45 mD and 40.91 mD.

When injecting the treatment fluid, the permeability of the tighter sample increased from 1.45 to 2.33 mD, indicating an enhancement of 61%. When compared with the 824% enhancement achieved with 3.4 folds, this result shows that the diversion efficiency decreases with increase in the permeability contrast.

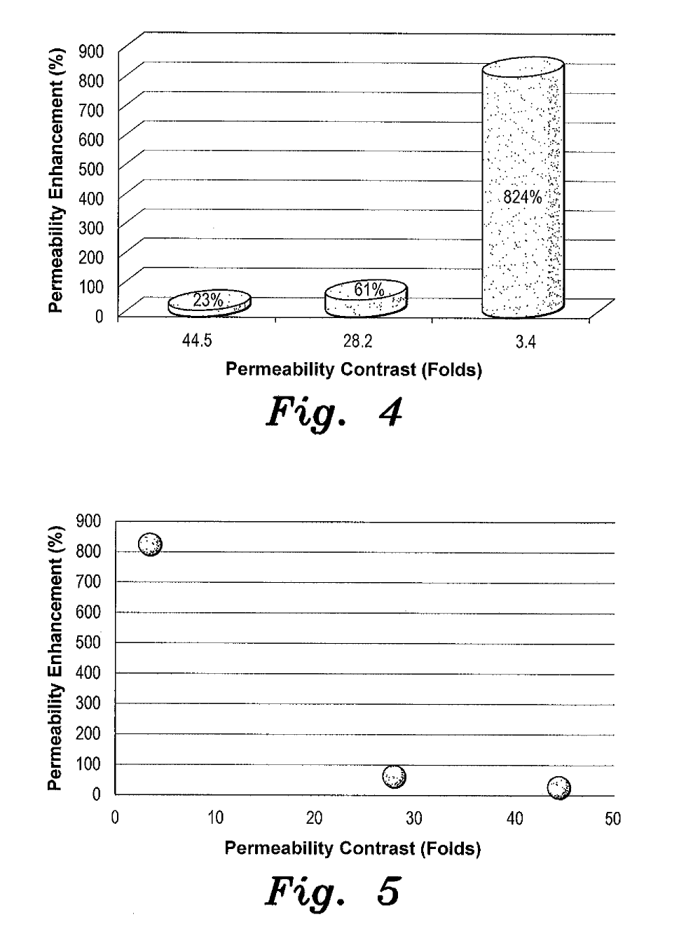

To investigate the limit in permeability contrast at which the treatment fluid is capable of diverting, a third experiment with higher permeability contrast was conducted, at a contrast of 44.5 folds. The permeability of the core samples was 0.7 mD and 31.25 mD. After injecting the treatment fluid, the tighter core sample permeability increased to 0.86 mD, indicating a low diversion efficiency of 23%. The present diverter was not able to divert effectively at such a high permeability contrast. Table 5 and FIG. 4 summarize the experiments conducted and their results. Although there was diversion in all three experiments, permeability contrast appears to be a major factor in diversion efficiency.

TABLE 5
Core Flooding Results

| | Core | Initial | Permeability | |
|---|---|---|---|---|
| Experiment | Sample | Permeability | Contrast | Enhancement |
| Number | Number | (mD) | (Folds) | (%) |
| 1 | 1 | 0.58 | 3.4 | 824 |
| | 12 | 2.00 | | Infinite |
| 2 | 11 | 1.45 | 28.2 | 61 |
| | 25 | 40.91 | | Infinite |
| 3 | 4 | 0.7 | 44.5 | 23 |
| | 21 | 31.25 | | Infinite |

The generated diversion enhancements from the three experiments are plotted in FIG. 5. The plot shows that the enhancement percentage decreases with increasing permeability contrast. It can further be seen that the relationship between the permeability contrast and diversion enhancement is not linear. Increasing the permeability contrast from 28.2 to 44.5 shows much lower impact than increasing the permeability contrast from 3.4 to 28.2 folds. The ratio of enhancement with permeability contrast increase for 3.4 and 28.2 folds is 30.8, while the ratio for 28.2 to 44.5 folds is 2.3. This indicates that the permeability contrast effect on treatment fluid diversion would reach a limit beyond which the treatment fluid is no longer able to divert, and that contrast limit can be interpolated to be around 60 folds using distilled water. However, when the VES is mixed in higher salinity water, the interpolated result could be higher.

The permeability contrast effect was evaluated at a lower concentration of VES (3.75% by volume) to evaluate the observed behavior at 7.5% vol VES. Permeability contrast was selected near to the ones used in the set evaluated at 7.5% VES. The permeability contrasts used were 5.6 and 38 folds. The diversion efficiency was evaluated for each one and compared to each other. For the first permeability contrast of 5.6, two core samples (samples 17 and 19) were selected with permeabilities of 4.95 mD and 27.50 mD, respectively.

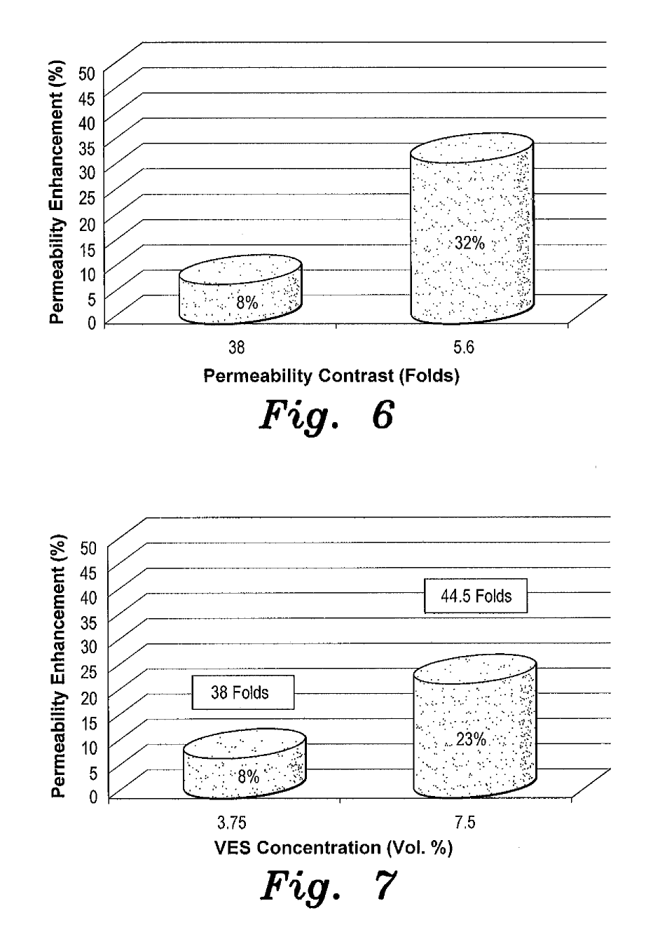

After injecting the treatment fluid, the permeability increased to 6.54 mD, indicating an enhancement of 32%. When increasing the permeability contrast to 32 using two core samples (samples 9 and 23) with permeabilities of 0.98 mD and 37.33 mD, respectively, the enhancement achieved decreased to 8% in the tight core sample. The results of the experiments are shown in FIG. 6. Diversion was achieved in both contrasts, but they showed different enhancements. The treatment fluid with a VES concentration of 3.75% showed a decrease in diversion efficiency when increasing the permeability contrast.

The concentration of the viscoelastic surfactant is believed to have a direct impact on the diversion efficiency of the treatment fluid, since the VES component is the material responsible for diversion. To evaluate the effect of VES concentration on diversion, the concentration was reduced by 50% (7.5% to 3.75%), and the results were compared to the ones obtained with 7.5% VES. The effect of VES concentration was analyzed by running several parallel core flooding experiments using different permeability contrasts. The two contrasts that were used were 38 and 44.5. The higher folds of 44.5 were used with the system containing 7.5% VES, while 38 folds were used with the system containing 3.75% VES.

Using 3.75% VES and core samples with 38 folds permeability contrast yielded a diversion efficiency of 8%, whereas using 7.5% VES and core samples with 44.5 folds resulted in 23% enhancement. The permeability contrast was lowered for the experiment that used 3.75% VES, which should allow for more diversion. However, due to the reduction in the VES concentration, the diversion efficiency decreased dramatically. As shown clearly in FIG. 7, the decrease in VES concentration from 7.5% to 3.75% causes a dramatic decrease in the diversion efficiency.

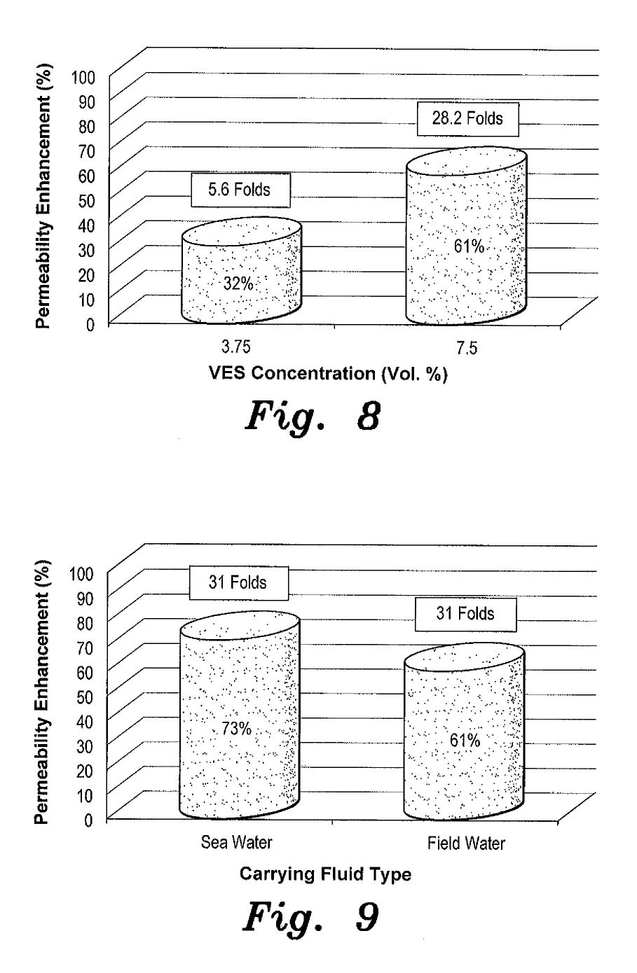

A similar observation on the effect of VES concentration was made by comparing the diversion efficiency of using 3.75% VES with a permeability contrast of 5.6 versus using 7.5% VES with a permeability contrast of 28.2. The results shown in FIG. 8 indicate that the 3.75% VES resulted in 32% enhancement in 5.6 fold permeability contrast core samples, whereas the 7.5% VES achieved 61% diversion efficiency in the 28.2 fold permeability contrast core samples.

The results generated from the experiments indicate that the diversion efficiency is a strong function of VES concentration. This can be explained, as the diversion achieved with the treatment fluid is a result of the viscosity generated by the VES interaction with the HCl acid reaction products. Increasing the VES concentration will increase the VES molecules present in the solution, which will offer greater viscosity to the reacted solution. The higher viscosity fluid will increase the blocking effect of the VES acid system, resulting in more diversion.

The salinity of the carrying fluid usually varies based on the available water or salts and the required carrying fluid density. The effect of the carrying fluid salinity on the diversion efficiency of the viscoelastic surfactant system was also studied. The study covered two extreme salinity ranges and a middle salinity. These were seawater (high salinity), field water (mid salinity), and distilled water (low salinity). The salinity effect of the carrying fluid was evaluated at two concentrations of VES, viz., 3.75% and 7.5%. Properties and composition of the water samples are shown in Table 1.

The three different salinity water samples were used to prepare the HCl solution, and then mixed with the other components in the treatment fluid. Each solution was used to stimulate two core samples in the parallel core flooding experiment, and the diversion efficiency was measured for each. Although some experiments have different permeability contrasts, they were chosen to be higher with increasing salinity to depict the diversion impact.

The salinity impact was first evaluated at a VES concentration of 3.75% using seawater and field water. For the seawater and field water salinities, core samples with permeability contrast of 31 folds were used to measure the diversion efficiency. As shown in FIG. 9, using seawater as the carrying fluid, the diversion efficiency obtained was 73%. When using the field water as a carrying fluid, the diversion efficiency was reduced to 61%. The reduction in the diversion efficiency shows the effect of salinity on the diversion efficiency of the treatment fluid. These results indicate that increasing the salinity from field water to seawater results in greater diversion.

The observation obtained from comparing the diversion of seawater and field water was further investigated by using lower salinity water; i.e., distilled water. Two permeability contrasts of 38 and 80.5 were used to evaluate the diversion of the treatment fluid using the carrying fluids, distilled water and seawater, respectively. The treatment fluid with distilled water as the carrying fluid resulted in a diversion efficiency of 8% using 38-fold permeability contrast core samples. Using the seawater as a carrying fluid for the treatment fluid, the diversion efficiency was 18% using the 80.5-fold core samples.

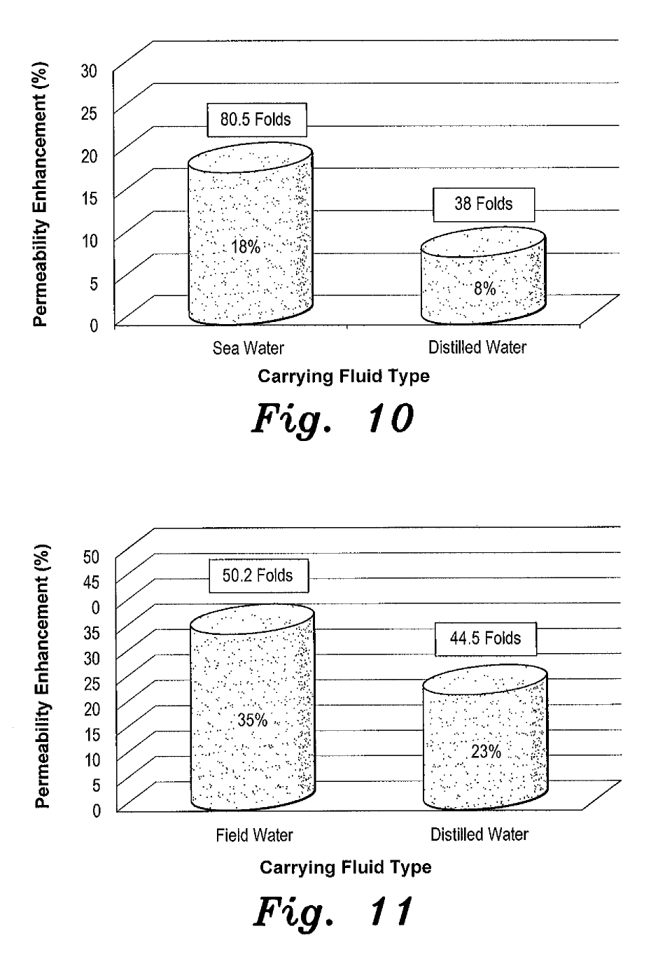

Although the permeability contrast (80.5 folds) in the seawater carrying fluid was much higher than the permeability contrast (38 folds) in the distilled water carrying fluid, it gave 10% higher in permeability enhancement. These results are shown in FIG. 10. The results indicate that the salinity of the carrying fluid of the treatment fluid has a significant impact on the diversion efficiency of the system. The results show that the diversion efficiency is proportional to the salinity of the carrying fluid within the salinity range in the experiments. The higher the salinity, the higher the diversion efficiency of the treatment fluid. In the field, this is more desirable, as it is easier to obtain saline water than low salinity water in most areas. The high salinity was shown to help in achieving a diversion, even if the treatment is applied in a very high contrast permeability carbonate reservoir.

The concentration of YES was increased to 7.5%, and the salinity effect on VES diversion was further evaluated. The water types used to evaluate the salinity at 7.5% VES were field water and distilled water, using permeability contrasts of 50.2 and 44.5, respectively. The stimulation of the 44.5 folds core samples using the distilled water as a carrying fluid resulted in an enhancement in the tighter core of 23%. When increasing permeability contrast to 50.2 and using field water mixed in the treatment fluid, the enhancement increased to 35%. FIG. 11 shows the diversion effect results of the salinity change. Although the 44.5 folds core sample was more favorable to increase diversion, the higher salinity in the field water was able to overcome the contrast difference and enhance the diversion of the treatment fluid. The results generated at 7.5% VES confirm the trend observed at 3.75% VES, i.e., increasing the salinity results in increasing the diversion efficiency.

The salinity effect in enhancing the diversion efficiency of the treatment fluid is attributed to the viscosity impact of having higher salinity carrying fluid. The increased VES fluid viscosity in the higher salinity water is believed to be due to the interaction of the VES materials of the treatment with the carrying fluid salt ions, such as CaCl₂. In the seawater sample, the concentration of Ca⁺⁺ is 592 mg/L, whereas in the field water sample, it is 126 mg/L. For the Cl⁻, the concentration in the seawater is 31,106 mg/L, whereas in the field water, it is 361 mg/L. For the distilled water, the concentration of both ions is very low.

There are other ions present, as shown in Table 1, which could also have an impact on viscosity. The significant differences in salt ion concentrations in the three types of water used in the study are believed to be the reasons behind the different diversion results. The salinity effect in 3.75% VES was shown to have greater impact by increasing the salinity from zero that of the field water than increasing the salinity from field water to that of seawater. Although there is a proportional relationship between the salinity and the diversion efficiency, there appears to be a decreasing effect of the salinity on diversion efficiency. Comparing the distilled water and field water to seawater, there is a diversion enhancement increase with a decreasing magnitude, which suggests that there may be a plateau value where salinity does not have any further effect on increasing diversion.

It is to be understood that the present invention is not limited to the embodiments described above, but encompasses any and all embodiments within the scope of the following claims.

We claim:

1. A composition for treating carbonate reservoirs, comprising:
about 7.5 vol % zwitterionic viscoelastic surfactant;
about 15.0 vol % hydrochloric acid; and
about 0.6 vol % corrosion inhibitor, the balance being brine.

2. The composition for treating carbonate reservoirs as recited in claim 1, wherein the zwitterionic viscoelastic surfactant comprises erucrylamidopropyl betaine.

3. A method for treating a carbonate reservoir, comprising the steps of:
injecting a treatment fluid into a non-problematic zone of a carbonate reservoir, the treatment fluid comprising about 7.5 vol % zwitterionic viscoelastic surfactant, about 15.0 vol % hydrochloric acid, about 0.6 vol % corrosion inhibitor, the balance being brine;
permitting the treatment fluid to gel as the hydrochloric acid reacts with carbonate of the carbonate reservoir, forming a diverting block in the non-problematic zone; and
injecting a further volume of the treatment fluid into the carbonate reservoir;
whereby the diverting block diverts the treatment fluid into a problematic zone of the carbonate reservoir.

4. The method for treating a carbonate reservoir as recited in claim 3, wherein the step of injecting the treatment fluid into the non-problematic zone comprises injecting the treatment fluid into the non-problematic zone at a rate of about 5 mL/min.

5. The method for treating a carbonate reservoir as recited in claim 4, wherein the step of injecting the further volume of treatment fluid into the carbonate reservoir comprises injecting the further volume of treatment fluid into the carbonate reservoir at a rate of about 5 mL/min.

6. A composition for treating carbonate reservoirs, comprising:
a zwitterionic viscoelastic surfactant, the surfactant being erucrylamidopropyl betaine;
hydrochloric acid;
a corrosion inhibitor; and
brine.

7. The composition for treating carbonate reservoirs as recited in claim 6, wherein the zwitterionic viscoelastic surfactant comprises about 7.5 vol % of the composition.

8. The composition for treating carbonate reservoirs as recited in claim 7, wherein the hydrochloric acid comprises about 15.0 vol % of the composition.

9. The composition for treating carbonate reservoirs as recited in claim 8, wherein the corrosion inhibitor comprises about 0.6 vol % of the composition.

10. The composition for treating carbonate reservoirs as recited in claim 9, wherein the balance of the composition comprises brine.
